(19) United States
(12) Patent Application Publication
(10) Pub. No.: US 2010/0156661 A1
(43) Pub. Date: Jun. 24, 2010

(54) Locator system and device

(76) Inventors: Kenneth L. Womack, Las Vegas, NV (US); Loretta J. Womack, Las Vegas, NV (US)

Correspondence Address: ROBERT RYAN MORISHITA;MORISHITA LAW FIRM, LLC, 8960 WEST TROPICANA AVENUE, SUITE 300, LAS VEGAS, NV, 89147, US

(21) Appl. No.: 12/653,783

(22) Filed: Dec. 18, 2009

Related U.S. Application Data
(60) Provisional application No. 61/203,035, filed on Dec. 19, 2008.

(51) Int. Cl. G08B 7/06

(52) U.S. Cl. 340/825.49

(57) ABSTRACT

A system for locating an object includes a transmitter and a receiver. A transmitter includes an actuator and a transmitter adapted to generate a radio-frequency signal in response to the actuator. The receiver is adapted to receive a radio-frequency signal and, in response to receipt of the radio-frequency signal, generate a locator signal. Optionally, the locator signal is an audio signal. Additionally or alternatively, the locator signal may include a visible signal.

### RELATED APPLICATION DATA

The present application claims the priority of U.S. Provisional Application Ser. No. 61/203,035, entitled “Sports & Soaps TV Remote Finder,” filed Dec. 19, 2008.

### FIELD OF THE INVENTION

The present invention relates to locator systems and devices. More specifically, the present invention includes a locator system including a receiver and signal device adapted to fit inside a remote controller and produce a locator signal in response to a radio-frequency signal produced by a transmitter.

### BACKGROUND OF THE INVENTION

A common problem in a household is the loss of small electronic devices such as remote controllers. That is, remote controllers are small and, by definition, not physically attached to a device, so they are often misplaced. Loss of a remote controller can be inconvenient, but also expensive.

One prior art solution includes trays or holders for remote controllers. However, the problem with such trays or holders is that the user must remember to place the remote controller in the tray or holder after use. The failure of the user to place the remote controller in a location where it can be found is exactly the problem these devices are supposed to solve. Thus, such devices are not particularly useful.

Thus, it can be seen that there is a need in the art for a locator system including a receiver and signal device adapted to fit inside a remote controller and produce a locator signal in response to a radio-frequency signal produced by a transmitter.

### SUMMARY OF THE INVENTION

An embodiment of the present invention includes a system for locating a wireless remote controller. In particular, a system is directed for use with a remote controller powered by at least one battery held in a battery compartment. The system includes a transmitter adapted to transmit a radio-frequency signal. In an optional embodiment, the transmitter transmits a radio-frequency signal between 900 and 1,800 megahertz, inclusive. An actuator is in electrical communication with the transmitter. The actuator triggers the transmission of the radio-frequency signal. Optionally, the transmitter and actuator are contained in a housing that can be attached to a surface.

The system also includes a receiver held in the battery compartment of the remote controller. The receiver is adapted to receive the radio-frequency signal transmitted by the transmitter. A signal device is in physical and electrical communication with the receiver. The signal device produces a locator signal in response to the receiver receiving the radio-frequency signal. Optionally, the locator signal is an audio signal. In a further optional embodiment, the locator signal is a periodic audio signal. In one such optional embodiment, a tone generator may be in electrical communication with the signal device to control the duration and period of the locator signal.

### BRIEF DESCRIPTION OF THE DRAWINGS

FIG. 1 is a block diagram of an embodiment of a transmitter according to the present invention;

FIG. 2 is a block diagram of a receiver according to an embodiment of the present invention;

FIG. 3 is a block diagram of a receiver according to an embodiment of the present invention;

FIG. 4 is an elevated perspective view of a transmitter according to an embodiment of the present invention;

FIG. 5 is an elevated perspective view of a transmitter mounted on a television according to an embodiment of the present invention;

FIG. 6 is an elevated perspective view of a receiver according to an embodiment of the present invention.

### DESCRIPTION

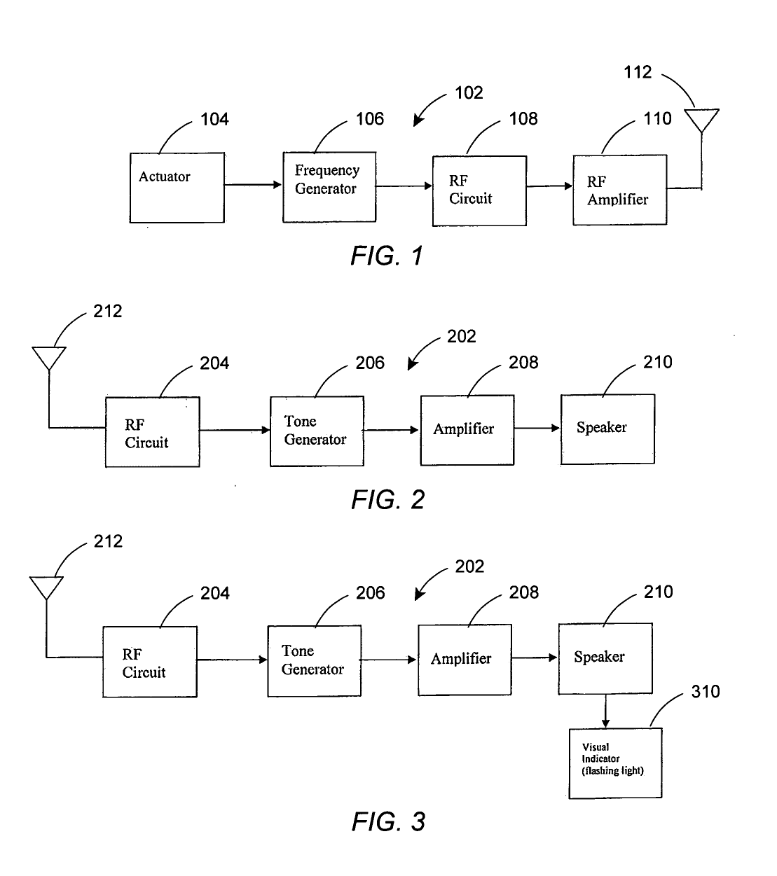

Reference is now made to the figures wherein like parts are referred to by like numerals throughout. Referring to FIGS. 1-6, the present invention includes a locator system and device. While the examples given below are directed to a locator system and device for locating a remote controller, it is contemplated that the locator system and device may be used for any object.

In an optional embodiment, a system includes two components, a transmitter 102 and a receiver 202. In the optional embodiment illustrated in FIG. 1, a transmitter may include an actuator 104 in electrical communication with a frequency generator 106. The frequency generator 106 cooperates with a radio-frequency circuit 108 and a radio-frequency amplifier 110 to generate and transmit a radio-frequency signal. Optionally, a transmitter antenna 112 may be provided to aid in the transmission of the radio-frequency signal.

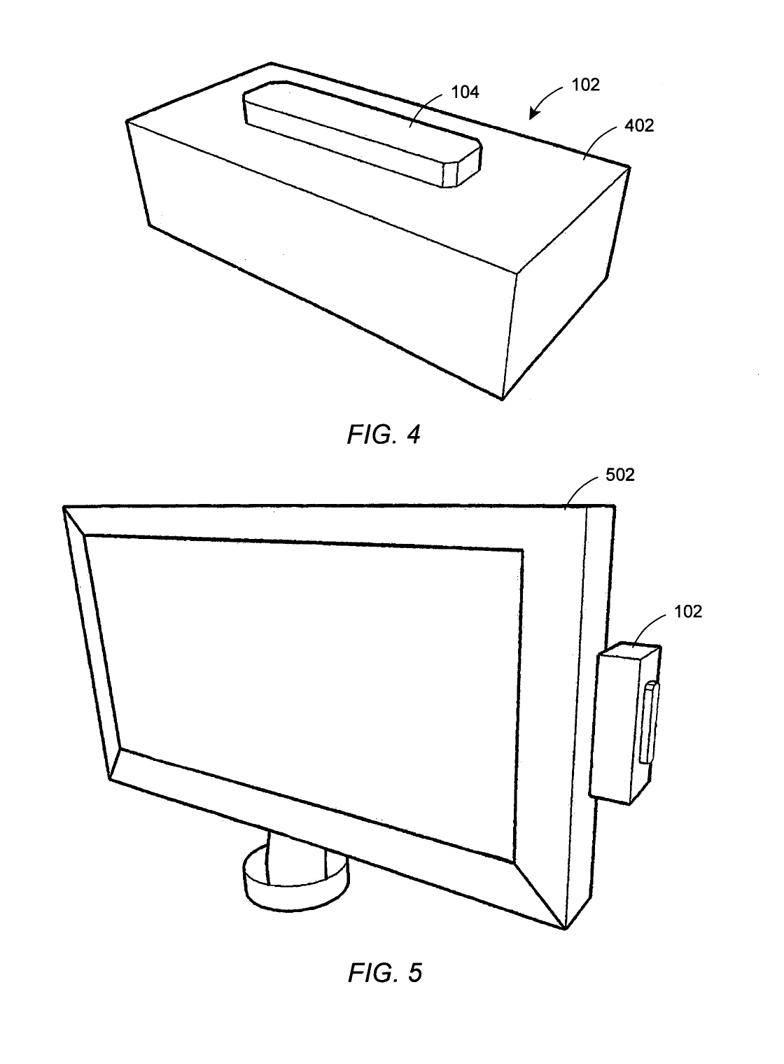

As shown in FIGS. 4 and 5, the transmitter may be contained in a housing 402 with the actuator 104 exposed. In an optional embodiment, the housing 402 may be attachable to a surface, such as a wall or cabinet, a piece of furniture, the electrical device, such as a television 502, controlled by the remote controller, or the like. In an optional embodiment, the attachment may take any form, including integrally forming the housing 402 with the surface or attaching it using a fastener, adhesive, or the like.

A system also includes a receiver 202. The receiver 202 may take many forms. As illustrated in FIGS. 2 and 3, a receiver 202 may include an antenna 212 to aid in receiving a radio-frequency signal from the transmitter 102. The antenna 212 communicates with a radio-frequency circuit 204. The radio-frequency circuit 204 cooperates with a tone generator 206 to create a locator signal in response to a radio-frequency signal received at the radio-frequency circuit 204. In an optional embodiment in which the locator signal is an audio signal, the locator signal may be transmitted to a signal device consisting of an amplifier 208 and speaker 210. In an additional or alternative optional embodiment in which the locator signal is visible, illustrated in FIG. 3, a signal device may additionally or alternatively include a light 310 or other visible signal.

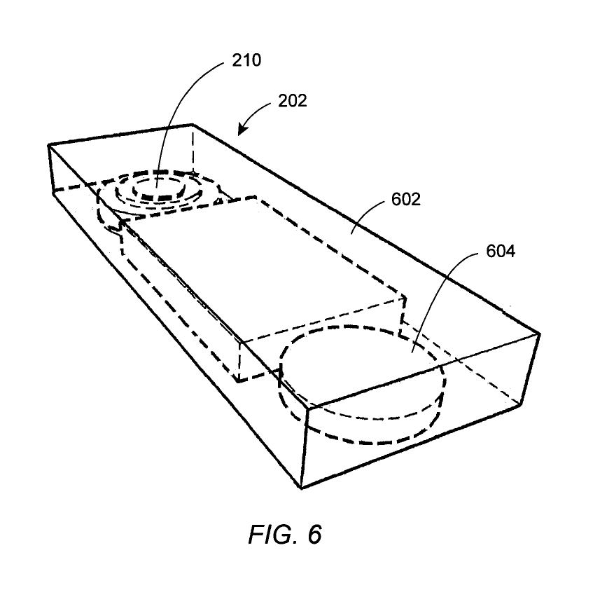

An optional embodiment of a receiver 202 is illustrated in FIG. 6. In this optional embodiment, the receiver 202 is contained within a receiver housing 602 and includes an internal battery 604 to power the transmitter 202 and signal device. In the optional embodiment of FIG. 6, the locator signal is an audio signal so the signal device includes a speaker 210. In additional or alternate optional embodiments, other means of signaling may be used, such as a light.

In the optional embodiment of FIG. 6, the receiver housing 602 is sized and shaped to fit inside the battery compartment of the remote controller to be located. Thus, in one optional embodiment, the receiver housing 602 is shaped to fit inside the battery compartment with the battery or batteries powering the remote controller. In another optional embodiment, the receiver housing 602 is shaped to fit inside the battery compartment in place of the batteries. In such an optional embodiment, the battery 604 powering the receiver 202 may be adapted to also power the remote controller.

In use, the frequency generator 106, radio-frequency circuit 108, and radio-frequency amplifier 110 (optionally cooperating with an antenna 112) in the transmitter 102 generate and transmit a radio-frequency signal in response to actuation of the actuator 104. Optionally, the radio-frequency signal has a frequency between 900 and 1,800 megahertz, inclusive.

The radio-frequency circuit 204 (optionally cooperating with an antenna 212) in the receiver 202 receives the radio-frequency signal. In response to receipt of the radio-frequency signal, a locator signal is generated. In an optional embodiment, the locator signal is a periodic audio signal. In one such optional embodiment, a tone generator 206 generates an audio signal of defined period and duration and converts that audio signal to an audible sound, optionally with the assistance of an amplifier 208 and speaker 210. In an additional or alternate optional embodiment, a visual indicator such as a light 310 may also be actuated in response to receipt of a radio-frequency signal at the receiver 202. It is the locator signal (whether audible, visible, or otherwise perceivable), that assists the user in locating the object, e.g. remote controller, holding the receiver.

While certain embodiments of the present invention have been shown and described it is to be understood that the present invention is subject to many modifications and changes without departing from the spirit and scope of the claims presented herein.

I claim:

1. A system for locating a wireless remote controller, said remote controller powered by at least one battery held in a battery compartment, comprising:
a transmitter adapted to transmit a radio-frequency signal;
an actuator in electrical communication with said transmitter, said actuator adapted to trigger the transmission of said radio-frequency signal;
a receiver held in said battery compartment of said remote controller, said receiver adapted to receive said radio-frequency signal transmitted by said transmitter; and
a signal device in physical and electrical communication with said receiver, said signal device adapted to produce a locator signal in response to said receiver receiving said radio-frequency signal.

2. The system of claim 1 wherein said locator signal is a periodic audio signal, said receiver further comprising a tone generator in electrical communication with said signal device, said tone generator adapted to generate said periodic locator signal.

3. The system of claim 1 wherein said transmitter is adapted to transmit a radio-frequency signal at between 900 and 1,800 megahertz, inclusive.
